(19) United States
(12) Patent Application Publication
(10) Pub. No.: US 2025/0254050 A1
(43) Pub. Date: Aug. 7, 2025

(54) INFORMATION PROCESSING APPARATUS, METHOD OF SETTING CERTIFICATE ISSUANCE REQUEST, AND STORAGE MEDIUM

(71) Applicant: CANON KABUSHIKI KAISHA, Tokyo (JP)

(72) Inventor: KEI SATO, Kanagawa (JP)

(21) Appl. No.: 19/041,922

(22) Filed: Jan. 30, 2025

(30) Foreign Application Priority Data
Feb. 6, 2024 (JP) 2024-016392

(51) Int. Cl. H04L 9/32; G06F 9/451

(52) U.S. Cl. CPC H04L 9/3268; G06F 9/451

(57) ABSTRACT

Provided is an information processing apparatus having: a request unit configured to request a certificate issuance server to issue an electronic certificate by using one of a plurality of protocols; an acceptance unit configured to accept selection of one of the plurality of protocols by a user and selection of one of a plurality of uses of the electronic certificate by the user; and a notification unit configured to make a notification related to a combination of the protocol and the use the selection of which was accepted by the acceptance unit.

### BACKGROUND OF THE INVENTION

### Field of the Invention

The present disclosure relates to setting of an electronic certificate issuance request protocol.

### Description of the Related Art

Public key infrastructure (PKI) technologies using electronic certificates have enabled secure network identification and authentication. For example, in a case where an information processing apparatus is a client, the information processing apparatus can verify the validity of a server by obtaining a server public key certificate from the server and a certificate authority certificate of a certificate authority which has issued that server public key certificate. Examples of communication protocols that use electronic certificates include Secure Sockets Layer (SSL), Transport Layer Security (TLS), IEEE 802.1X, Security Architecture for Internet Protocol (IPsec), and so on.

Also, in a case of requesting a certificate authority to issue an electronic certificate (hereinafter “certificate”), an information processing apparatus can use a predetermined certificate issuance request protocol to request issuance of the certificate without the user's operation. Japanese Patent Laid-Open No. 2023-078380 discloses a multi function peripheral that uses Simple Certificate Enrollment Protocol (SCEP) as a certificate issuance request protocol.

There are various types of certificate issuance request protocols (hereinafter “protocols”), and each protocol has different functions and characteristics. Therefore, which protocol to use is determined based on the use of the certificate, the required security level, and the like. Examples include cases such as using Automatic Certificate Management Environment (ACME) to obtain a certificate for TLS, using Enrollment over Secure Transport (EST) to obtain a certificate for IEEE 802.1X, and so on.

Thus, in an environment in which multiple protocols (e.g., SCEP, EST, and ACME) are usable, it is possible to implement specific functions and achieve a required level of security by selecting an appropriate protocol based on the use. There is, however, a possibility of failing to achieve the functions and the security level that are supposed to be available in a case where the protocol and the use of the certificate do not match.

An object of the present disclosure is to prevent a user from erroneously configuring settings for requesting issuance of an electronic certificate in an environment in which multiple certificate issuance request protocols are usable, and thus improve user friendliness.

### SUMMARY OF THE INVENTION

An information processing apparatus of the present disclosure has: a request unit configured to request a certificate issuance server to issue an electronic certificate by using one of a plurality of protocols; an acceptance unit configured to accept selection of one of the plurality of protocols by a user and selection of one of a plurality of uses of the electronic certificate by the user; and a notification unit configured to make a notification related to a combination of the protocol and the use the selection of which was accepted by the acceptance unit.

Further features of the present invention will become apparent from the following description of exemplary embodiments with reference to the attached drawings.

### BRIEF DESCRIPTION OF THE DRAWINGS

FIG. 1 is a diagram illustrating a configuration of a system according to an embodiment of the present disclosure;

FIG. 2 is a diagram illustrating a hardware configuration of a multi function peripheral;

FIG. 3 is a diagram illustrating a software configuration of the multi function peripheral;

FIGS. 4A and 4B are tables indicating a priority of each of combinations of a certificate use and a certificate issuance request protocol and whether the combination is usable;

FIG. 5 is a diagram illustrating a hardware configuration of a personal computer (PC);

FIG. 6 is a diagram illustrating a software configuration of the PC;

FIG. 7 is a diagram illustrating a functional arrangement for requesting issuance of a certificate;

FIG. 8 is a sequence chart of a process of configuring settings for connecting to a certificate authority and registration authority and a process of requesting the certificate authority and registration authority to issue a certificate;

FIG. 9 is a diagram illustrating an example of a connection setting screen;

FIG. 10 is an example of a setting screen for requesting issuance of a certificate by SCEP;

FIG. 11 is an example of a setting screen for requesting issuance of a certificate by EST;

FIG. 12 is an example of a setting screen for requesting issuance of a certificate by ACME;

FIG. 13 is a flowchart illustrating a flow of a certificate issuance request setting process;

FIG. 14 is an example of a notification related to a combination of a certificate issuance request protocol and a use;

FIG. 15 is an example of a setting screen for setting the priorities of protocols for certificate uses;

FIG. 16 is a flowchart illustrating a flow of a certificate issuance request setting process in a second embodiment;

FIG. 17 is a flowchart illustrating a flow of a certificate issuance request setting process in a third embodiment;

FIG. 18 is a flowchart illustrating a flow of a certificate issuance request setting process in a fourth embodiment;

FIG. 19 is an example of an SCEP certificate issuance request setting screen with user interface (UI) elements masked;

FIG. 20 is an example of an EST certificate issuance request setting screen with UI elements masked;

FIG. 21 is an example of an ACME certificate issuance request setting screen with an UI element masked; and

FIG. 22 is a flowchart explaining display control based on the priorities of combinations of a protocol and a use.

### DESCRIPTION OF THE EMBODIMENTS

Hereinafter, with reference to the attached drawings, the present disclosure explains some example embodiments in detail. Configurations shown in the following embodiments are merely exemplary and some embodiments of the present disclosure are not limited to the configurations shown schematically.

The description will be given with a multi function peripheral (digital multi function peripheral (MFP)) taken as an example of an information processing apparatus according to each of the embodiments that manages usage of electronic certificates and the electronic certificates. However, the scope of application of the present disclosure is not limited to multi function peripherals, and includes image forming apparatuses and various information processing apparatuses capable of using electronic certificates.

### First Embodiment

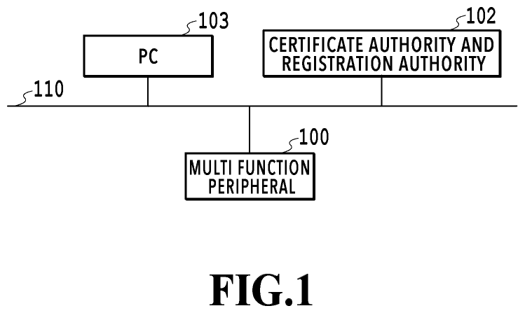

FIG. 1 is a diagram explaining a system configuration of an information processing system including a multi function peripheral 100 according to a first embodiment of the present disclosure.

The multi function peripheral 100, which has a printing function, is communicatively connectable to other information processing apparatuses through a network 110. The multi function peripheral 100 is capable of exchanging print data, image data obtained by scanning, management information of devices, and so on with the other information processing apparatuses through the network 110. The multi function peripheral 100 has a function of performing multiple types of encrypted communication by TLS, IPsec, IEEE 802.1X, etc. The multi function peripheral 100 holds public key pairs and electronic certificates (hereinafter “certificates”) to be used in those encryption processes.

The multi function peripheral 100 has a web server function and makes a web page-type Remote UI (hereinafter “RUI”) function public on the network 110. Specifically, the multi function peripheral 100 provides various setting screens and operation screens to a PC 103 connected thereto through the network 110 via RUIs. For example, the multi function peripheral 100 provides an RUI including a setting screen for inputting information necessary for requesting issuance of a certificate to the PC 103. The setting screens will be described later.

Note that the multi function peripheral 100 is an example of an image forming apparatus, which is not limited to the above and may be an apparatus having the function of a facsimile, a printer, or a copying machine alone or the functions of a combination of these.

A certificate authority and registration authority 102 has the function of a certificate authority CA that issues certificates and the function of a registration authority RA that performs a process of accepting certificate issuance requests and registering certificates. Specifically, the certificate authority and registration authority 102 is a server apparatus having a function of distributing CA certificates through the network 110 and issuing and registering the certificates. Information processing apparatuses such as the multi function peripheral 100 use certificate issuance request protocols for requesting issuance of certificates (hereinafter also simply “protocols”) to perform communication with the certificate authority and registration authority 102 through the network 110 for requesting issuance of certificates and obtaining certificates. The multi function peripheral 100 functions as a client with the certificate authority and registration authority 102.

In response to receiving a certificate issuance request from an information processing apparatus such as the multi function peripheral 100 or the PC 103 through the network 110, the certificate authority and registration authority 102 performs a process of issuing and registering a certificate based on that issuance request, and transmits the issued certificate as a response to the issuance request. Note that, in the present embodiment, an example in which the functions of a certificate authority and a registration authority are implemented by the same server apparatus has been described, but a configuration in which the functions of a certificate authority and a registration authority are implemented by different server apparatuses may be employed instead. Also, in the present embodiment, SCEP, ACME, and EST are exemplarily described as the certificate issuance request protocols used between the multi function peripheral 100 and the certificate authority and registration authority 102. The certificate authority and registration authority 102 may be configured of a single server apparatus, or different server apparatuses may be provided for the respective protocols like an SCEP server, an ACME server, and an EST server.

The PC 103 is a personal computer and equipped with a web browser function. With the web browser function, hypertext markup language (HTML) documents and web sites that have been made public by the information processing apparatuses connected to the network 110 (such as the multi function peripheral 100) can be browsed and used on the PC 103. Using the web browser function, the user of the PC 103 can access the RUIs of the multi function peripheral 100 and configure settings of the multi function peripheral 100. For example, using the web browser installed on the PC 103, the user of the multi function peripheral 100 connects to a web page for requesting issuance of a certificate and obtaining that certificate that has been made public by the multi function peripheral 100, and inputs information necessary for requesting issuance of the certificate. In accordance with the information input by the user, the multi function peripheral 100 transmits a certificate issuance request to the certificate authority and registration authority 102 by one of the protocols selected from among SCEP, ACME, and EST by the user. In response to obtaining a certificate from the certificate authority and registration authority 102, the multi function peripheral 100 configures how to use the obtained certificate on the multi function peripheral 100 in accordance with information input by the user.

Next, a configuration of the multi function peripheral 100 according to the present embodiment will be described.

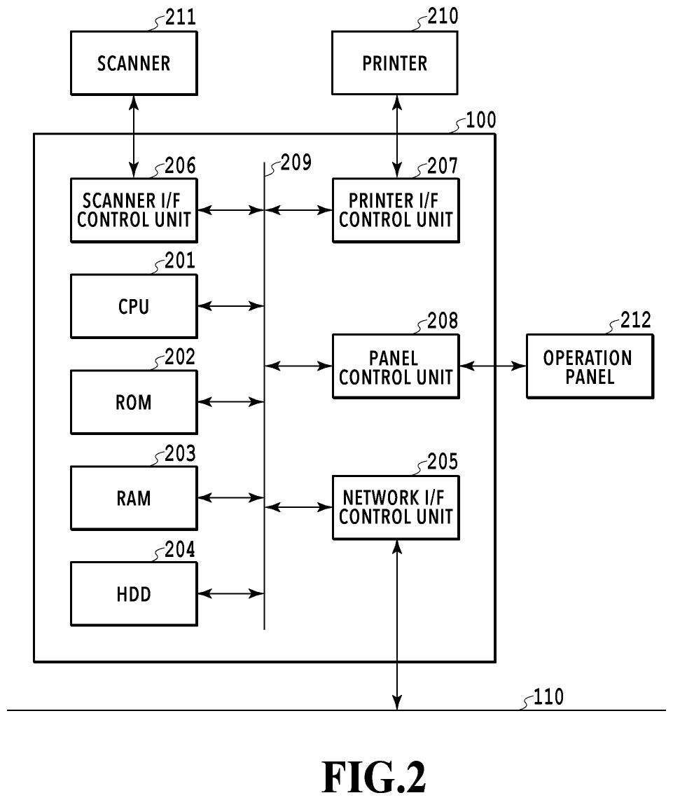

FIG. 2 is a block diagram illustrating a hardware configuration of the multi function peripheral 100 according to the present embodiment. A central processing unit (CPU) 201 executes software programs for the multi function peripheral 100 to control the whole apparatus. A read-only memory (ROM) 202 stores a boot program for the multi function peripheral 100, fixed parameters, and so on. A random access memory (RAM) 203 is used by the CPU 201 for storage of programs and temporary data and so on during control of the multi function peripheral 100. A hard disk drive (HDD) 204 stores system software, applications, and various data.

The CPU 201 controls the operation of the multi function peripheral 100 by executing the boot program stored in the ROM 202, loading a program stored in the HDD 204 into the RAM 203, and executing the loaded program. A network I/F control unit 205 controls transmission and reception of data to and from the network 110. A scanner I/F control unit 206 controls scanning of documents by a scanner 211. A printer I/F control unit 207 controls print processing and the like by a printer 210. A panel control unit 208 controls a touch panel-type operation panel 212 to control display of various information and input of instructions from the user. A bus 209 connect the CPU 201, the ROM 202, the RAM 203, the HDD 204, the network I/F control unit 205, the scanner I/F control unit 206, the printer I/F control unit 207, and the panel control unit 208 to one another. Control signals from the CPU 201 and data signals between apparatuses are transmitted and received through the bus 209.

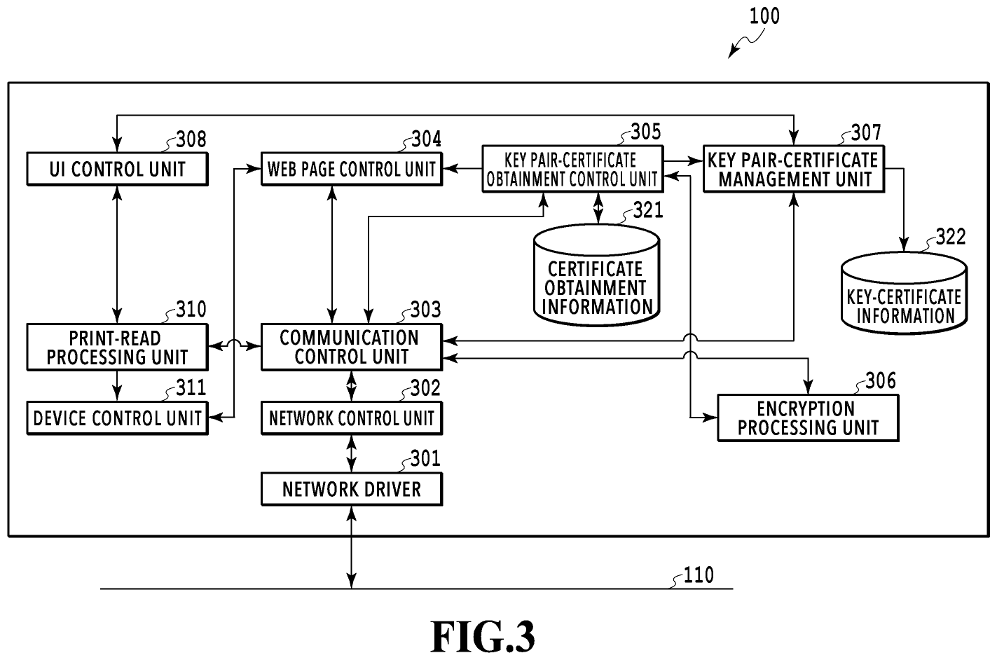

FIG. 3 is a block diagram explaining software modules included in the multi function peripheral 100 according to the present embodiment. Note that the software modules illustrated in FIG. 3 are implemented by the CPU 201 loading a program into the RAM 203 and executing it.

A network driver 301 controls the network I/F control unit 205 connected to the network 110 to externally transmit and receive data through the network 110.

A network control unit 302 controls communication at and below the transport layer in a network communication protocol, such as Transmission Control Protocol/Internet Protocol (TCP/IP), to transmit and receive data.

A communication control unit 303 is a module for performing control by the multiple communication protocols supported by the multi function peripheral 100. In a certificate obtaining process complying with a certificate issuance request protocol in the present embodiment, the communication control unit 303 makes requests for communication by protocols such as HyperText Transfer Protocol (HTTP) and Simple Object Access Protocol (SOAP), performs a process of generating and analyzing response data, and controls data transmission and reception. Also, the communication control unit 303 executes communication with the certificate authority and registration authority 102 and the PC 103. Moreover, the communication control unit 303 executes encrypted communication by the protocols supported by the multi function peripheral 100, such as TLS, IPsec, and IEEE 802.1X.

TLS is a protocol for performing secure communication that is mainly used between protocols at the transport layer and the application layer. For example, it is combined with HTTP as HTTP Secure (HTTPS) to provide a secure communication protocol. Note that TLS is not dependent on a particular protocol at the application layer, and is used in combination with various protocols. In the present embodiment, TLS refers to HTTPS unless otherwise noted.

IPsec is a protocol for protecting communication by authenticating and encrypting IP packets at the network layer.

IEEE 802.1X is an authentication standard used at the data link layer in a case of connecting to a local area network (LAN), and is a quarantine network technology for preventing apparatuses other than those authorized from connecting to the LAN.

A web page control unit 304 is a module that generates HTML data for displaying an RUI (web page) for requesting issuance of a certificate and obtaining that certificate, and performs communication control, for example. The web page control unit 304 executes processes in response to web page display requests, certificate issuance requests, and certificate obtaining instructions sent from the network driver 301 through the communication control unit 303. The web page control unit 304 transmits the HTML data of a preset web page saved in the RAM 203 or the HDD 204 or HTML data generated based on the content of a display request as a response to a request from a web browser 604.

A key pair-certificate obtainment control unit 305 is a module for executing a certificate obtaining process in accordance with an instruction from the web page control unit 304. The key pair-certificate obtainment control unit 305 saves setting values related to a certificate issuance request process and controls communication by the certificate issuance request protocols. The key pair-certificate obtainment control unit 305 also performs a process of generating and analyzing encrypted data necessary for communication by PKCS #7, PKCS #10, or the like, and a process of saving an obtained certificate, setting its use, etc. The setting values and information handled by the key pair-certificate obtainment control unit 305 are saved in certificate obtainment information 321.

The certificate obtainment information 321 is a database to save the data which the key pair-certificate obtainment control unit 305 uses for its processes. The information in the certificate obtainment information 321 is saved in the HDD 204, for example. The certificate obtainment information 321 includes a first table 401 indicating the order of priority (priorities) of combinations of a certificate use and a certificate issuance request protocol, and a second table 402 indicating, for each combination of a certificate use and a certificate issuance request protocol, whether the combination is usable.

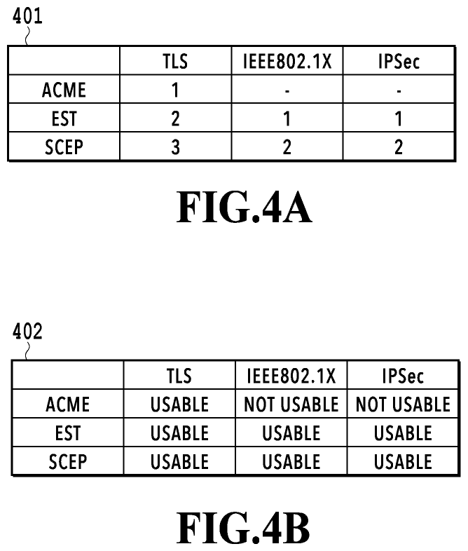

FIG. 4A illustrates an example of the first table 401 indicating the order of priority (priorities) of combinations of a certificate use and a certificate issuance request protocol. FIG. 4B illustrates an example of the second table 402 indicating, for each combination of a certificate use and a certificate issuance request protocol, whether the combination is usable.

Each row in the first table 401 illustrated in FIG. 4A indicates a certificate issuance request protocol supported by the multi function peripheral 100 while each column indicates a certificate use (encrypted communication protocol) supported by the multi function peripheral 100. In the first table 401, a smaller numeric value means a higher priority. Specifically, for the use “TLS,” ACME, EST, and SCEP are ranked in this sequence in descending order of priority. Also, for the uses “IEEE 802.1X” and “IPsec,” EST and SCEP are ranked in this sequence in descending order of priority. The priorities are preferably determined based on the functions and security levels of the certificate issuance request protocols.

With ACME, owing to its specifications, the server (certificate authority and registration authority 102) side can verify after issuing a certificate whether the issuance destination of the certificate and the client (the certificate issuance request source, such as the multi function peripheral 100) match. Certificates issued using ACME are assumed to be used with TLS, and IEEE 802.1X and IPsec are not considered their uses. The specifications of ACME have been made public as RFC 8555.

With EST, the server (certificate authority and registration authority 102) side cannot verify after issuing a certificate whether the issuance destination of the certificate and the client (the certificate issuance request source, such as the multi function peripheral 100) match. Also, EST assumes that TLS is used for communication between the server and the client. The use of certificates issued using EST is not particularly limited, and the certificates can be used with TLS, IEEE 802.1X, IPsec, and the like. The specifications of EST have been made public as RFC 7030.

With SCEP, the server (certificate authority and registration authority 102) side cannot verify after issuing a certificate whether the issuance destination of the certificate and the client (the certificate issuance request source, such as the multi function peripheral 100) match. Also, with SCEP, it is not essential to use TLS for communication between the server and the client. The use of certificates issued using SCEP is not particularly limited, and the certificates can be used with TLS, IEEE 802.1X, IPsec, and the like. The specifications of SCEP have been made public as RFC 8894.

Considering each protocol's characteristic features as described above, ACME, EST, and SCEP are ranked in this sequence in descending order of security in a case where the use is TLS. The reason for this sequence is that with ACME the server side can verify after issuing a certificate whether the issuance destination of the certificate and the client match but the server side cannot do this with SCEP or EST, and also that EST provides enhanced security as compared to SCEP.

In a case where the use is IEEE 802.1X and in a case where the use is IPsec, EST and SCEP are ranked in this sequence in descending order of security. The reason for this sequence is that IEEE 802.1X and IPsec are not considered uses for ACME, in addition to the reason with TLS. The values of IEEE 802.1X and IPsec in the “ACME” row in the first table 401 are “-” (no priority) because ACME supports neither IEEE 802.1X nor IPsec as a certificate use in the present embodiment.

Note that the priority of each protocol for each use may be set and held in advance as described in the present embodiment, or settings configured by the user of the multi function peripheral 100 may be accepted using a setting screen (RUI). The setting of the priorities by the user will be described later.

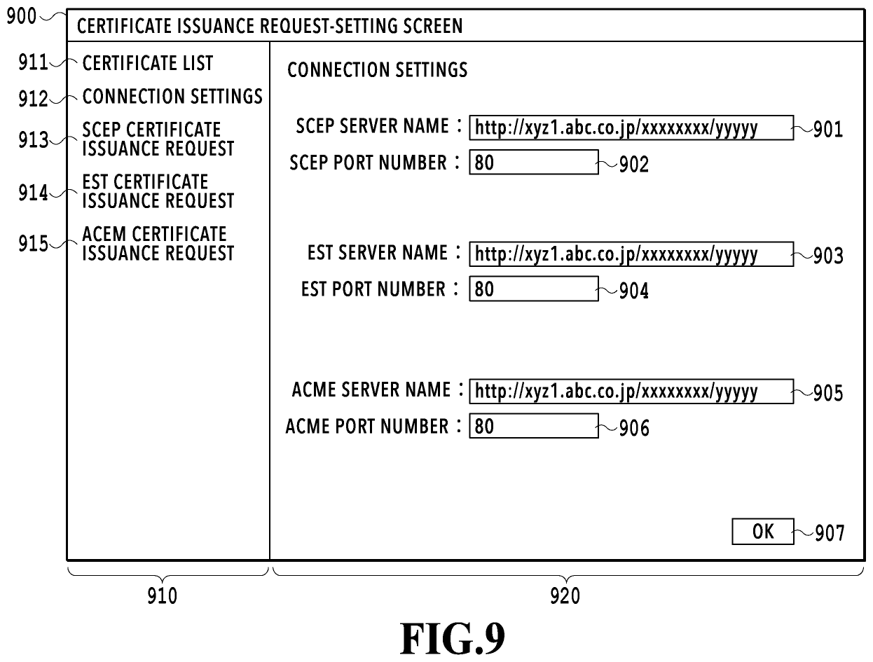

Each row in the second table 402 in FIG. 4B indicates a certificate issuance request protocol (request method) supported by the multi function peripheral 100 while each column indicates a certificate use (communication protocol) supported by the multi function peripheral 100. The example of FIG. 4B assumes that the user has configured connection settings for each of SCEP, EST, and ACME on the connection setting screen to be described later (FIG. 9). Also, all of the combinations excluding some combinations are set as “USABLE.” Specifically, the combination of ACME and IEEE 802.1X as a use and the combination of ACME and IPsec as a use are set as “NOT USABLE.” This is because IEEE 802.1X and IPsec are not considered certificate uses in the specifications of ACME. Note that a combination with a protocol whose connection settings have not been configured by the user is set as not usable in the multi function peripheral 100 even in a case where the combination is usable according to the specifications of the protocol. For each protocol, whether it is usable or not saved in the second table 402 in FIG. 4B.

The description now returns to FIG. 3.

Key-certificate information 322 is a database in which key pairs and certificates and CA certificates to be used by the multi function peripheral 100 are saved. CA certificates may be held in the key-certificate information 322 as reliable certificates from the start, or the user of the multi function peripheral 100 may add and save key pairs and certificates and CA certificates later.

An encryption processing unit 306 is a module for executing various encryption processes such as encryption and decryption of data, generation and verification of electronic signatures, and generation of hash values. The encryption processing unit 306 executes encryption processes necessary in the certificate issuance request process.

A key pair-certificate management unit 307 is a module that manages the public key pairs and certificates held in the multi function peripheral 100. The key pair-certificate management unit 307 saves data of the public key pairs and certificates in the RAM 203 or the HDD 204 along with various setting values. Also, while not illustrated in the present embodiment, processes of displaying details of the public key pairs and certificates, generating the public key pairs and certificates, deleting the public key pairs and certificates, and other similar operations can be executed in response to user instructions on the operation panel 212. A UI control unit 308 controls the operation panel 212 and the panel control unit 208.

Note that, in encrypted communication processes by TLS, IPsec, and IEEE 802.1X or the like executed by the communication control unit 303, too, the encryption processes are performed by the encryption processing unit 306 and the public key pairs and certificates to be used are obtained from the key pair-certificate management unit 307.

A print-read processing unit 310 is a module for executing functions such as printing with the printer 210 and reading of a document with the scanner 211.

A device control unit 311 is a module for comprehensively controlling the multi function peripheral 100 by generating control commands and control data for the multi function peripheral 100.

Next, a configuration of the PC 103 will be described.

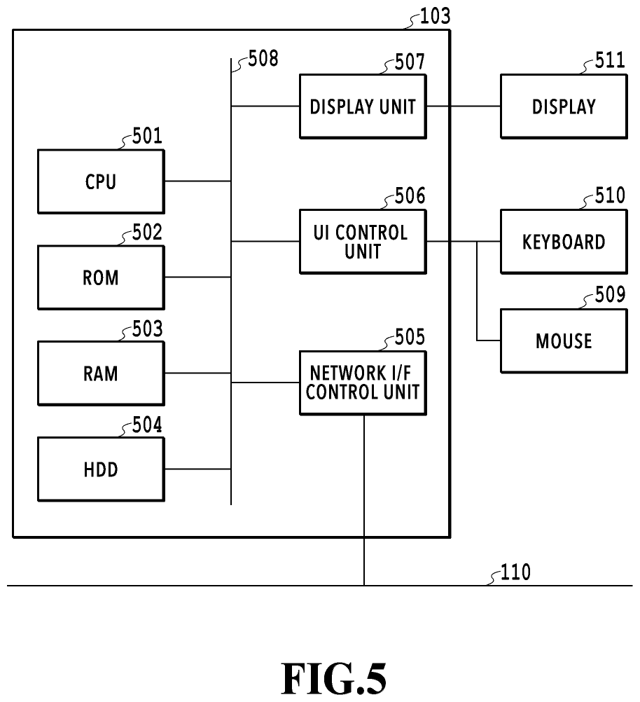

FIG. 5 is a block diagram illustrating a hardware configuration of the PC 103 according to the present embodiment.

A CPU 501 executes software programs for the PC 103 to control the whole apparatus. A ROM 502 stores a boot program for the PC 103, fixed parameters, and so on. A RAM 503 is used by the CPU 501 for storage of programs and temporary data and so on during control of the PC 103. An HDD 504 stores system software, applications, and various data.

The CPU 501 controls the operation of the PC 103 by executing the boot program stored in the ROM 502, loading a program stored in the HDD 504 into the RAM 503, and executing the loaded program. A network I/F control unit 505 controls transmission and reception of data to and from the network 110. A UI control unit 506 controls input processes with operations on a mouse 509 and a keyboard 510. A display unit 507 controls a display 511, and controls display of various information. A bus 508 connects the CPU 501, the ROM 502, the RAM 503, the HDD 504, the network I/F control unit 505, the UI control unit 506, and the display unit 507 to one another. Control signals from the CPU 501 and data signals between devices are transmitted and received through the bus 508.

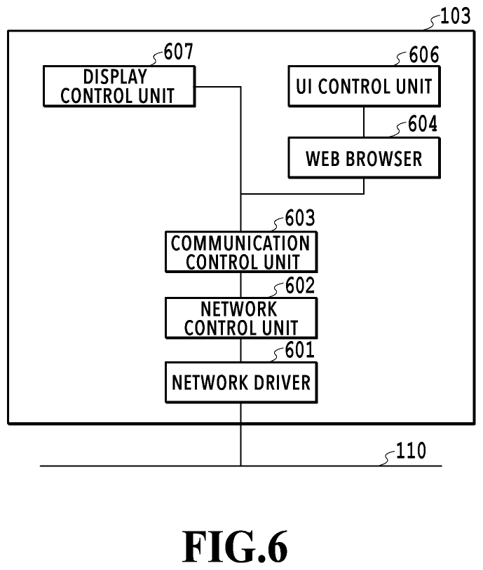

FIG. 6 is a block diagram explaining software modules included in the PC 103 according to the present embodiment. Note that these software modules illustrated in FIG. 6 are implemented by the CPU 501 loading a program into the RAM 503 and executing it.

A network driver 601 controls the network I/F control unit 505 connected to the network 110 to externally transmit and receive data through the network 110.

A network control unit 602 controls communication at and below the transport layer in a network communication protocol, such as TCP/IP, to transmit and receive data.

A communication control unit 603 is a module for performing control by the multiple communication protocols supported by the PC 103. In the present embodiment, the communication control unit 603 makes requests for communication by protocols such as HTTP and SOAP, performs a process of generating and analyzing response data, controls data transmission and reception, and accesses the RUIs of the multi function peripheral 100 to configure certificate obtaining settings.

The web browser 604 is an application for displaying web pages that have been made public by the multi function peripheral 100 and for performing operations on the web pages.

A display control unit 607 controls the screens to be displayed on the display 511 by the web browser 604. A UI control unit 606 controls inputs from the mouse 509 and the keyboard 510 for performing various operations on the web browser 604.

Next, a functional arrangement of the multi function peripheral 100 for implementing a method of setting a certificate issuance request according to the present embodiment will be described.

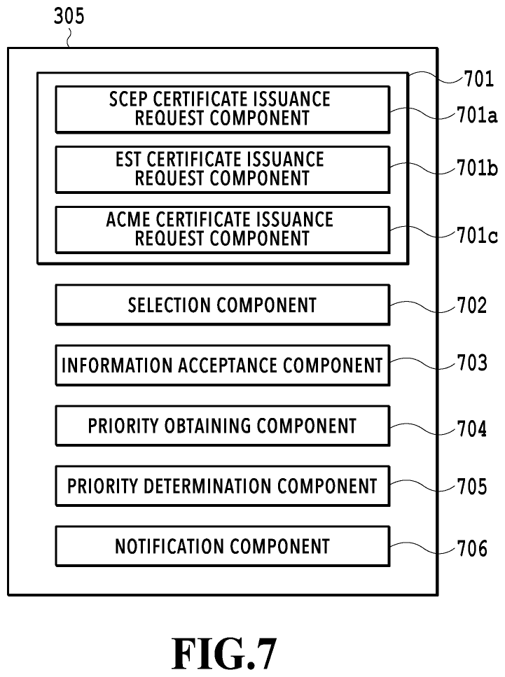

FIG. 7 is a diagram illustrating the functional arrangement for the multi function peripheral 100 to implement the method of setting a certificate issuance request according to the present disclosure. As illustrated in FIG. 7, the multi function peripheral 100 has a certificate issuance request component 701, a selection component 702, an information acceptance component 703, a priority obtaining component 704, a priority determination component 705, a notification component 706, and so on. These functions are included in the key pair-certificate obtainment control unit 305 illustrated in FIG. 3 and are implemented by the CPU 201 executing programs corresponding to the respective functions.

The certificate issuance request component 701 is a function that requests the certificate authority and registration authority 102 to issue a certificate. The certificate issuance request component 701 requests the certificate authority and registration authority 102, which is a certificate issuance server, to issue a certificate by a certificate issuance request protocol (hereinafter “request method”) selected by the user with the selection component 702, and obtains the certificate. The certificate issuance request process will be described later.

The selection component 702 accepts selection of a certificate issuance request protocol by the user. In the present embodiment, one protocol can be selected from among SCEP, EST, and ACME, but the protocols are not limited to these and may include other protocols. Also, not all of these protocols need to be included, and the selection component 702 may accept selection from between two of the protocols.

The information acceptance component 703 accepts input of information necessary for requesting issuance of a certificate. The information acceptance component 703 displays a certificate issuance request setting screen provided with setting items corresponding to the certificate issuance request protocol (hereinafter “setting screen”) in an RUI, for example. The information acceptance component 703 also accepts input of information by the user through the RUI. Information necessary for requesting issuance of a certificate includes the use of the certificate. Details of the setting screen will be described later (FIGS. 9 to 12).

The priority obtaining component 704 obtains information indicating the priority of a combination of each of multiple certificate uses and each of the multiple certificate issuance request protocols. Specifically, as in the first table 401 illustrated in FIG. 4A, values indicating levels of priority, such as “1,” “2,” “3,” . . . , are set as the priorities of the combinations of a protocol and a use. The priority “1” is the highest level of priority, followed by the priorities “2,” “3,” . . . in this order. No priority is set for the combinations that are not usable. Incidentally, the priorities do not necessarily have to be held in the form of a table, and may be held in any form as long as the CPU 201 can obtain it. Note that the priority obtaining component 704 also obtains information indicating, for each combination of a certificate use and a protocol, whether the combination is usable or not usable (the second table 402 in FIG. 4B).

The priority determination component 705 determines whether the combination of a certificate use selected by the user and the protocol selected by the user is usable, and also whether a combination with a higher priority is present. Based on the result of this determination, whether to request the certificate authority and registration authority 102 to issue a certificate or to make a notification with the notification component is controlled.

The notification component 706 determines whether the priority determination component 705 has determined that the combination of the certificate use and the protocol selected by the user is usable and a combination with a higher priority is present. If determining that the combination is usable and a combination with a higher priority is present, the notification component 706 makes a notification indicating that a combination with a higher priority is present. The notification may be displayed on a screen through an RUI or given to the user by e-mail or another notification method, for example.

Note that, in a case where the priority determination component 705 determines that the combination of the certificate use and the protocol selected by the user is not usable or no combination with a higher priority is present, the certificate issuance request component 701 requests issuance of a certificate.

Next, a flow of processing for the multi function peripheral 100 to request issuance of a certificate in the information processing system in the present embodiment will be described.

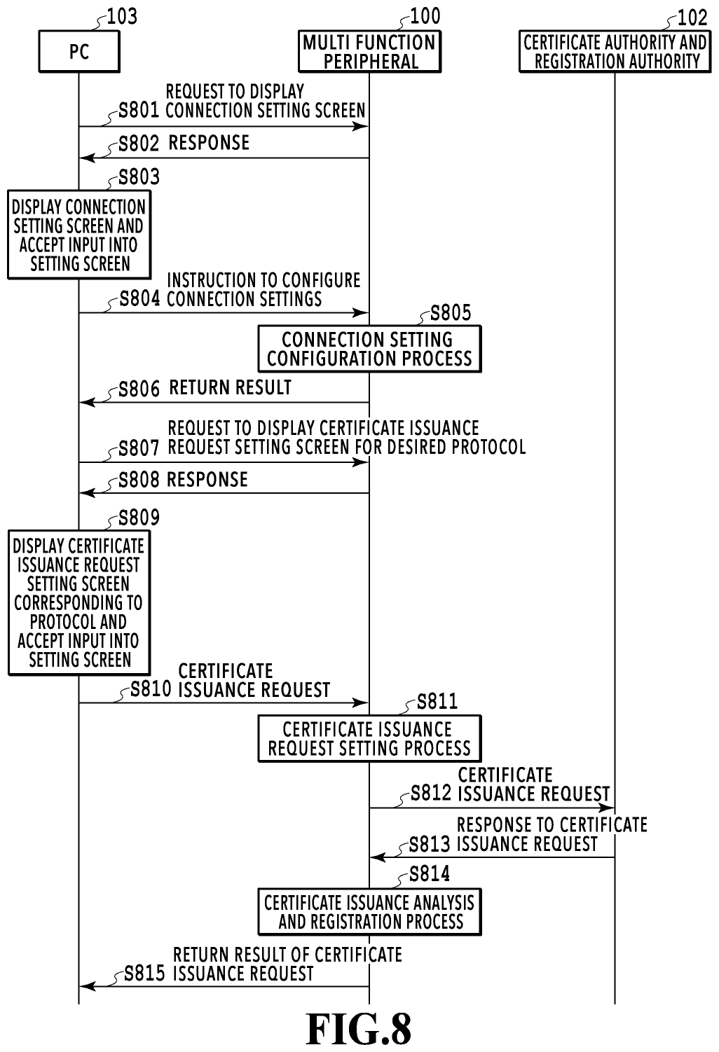

FIG. 8 is a sequence chart explaining an entire flow of processing including a connection setting process, a certificate issuance request setting process, and a certificate issuance request process.

S801 to S806 are the connection setting process, indicating a procedure for setting information necessary for the multi function peripheral 100 to connect to the certificate authority and registration authority 102 (connection setting information). The connection setting process is performed before the multi function peripheral 100 requests the certificate authority and registration authority 102 to issue a certificate. In the present embodiment, it is performed before the certificate issuance request setting process.

S807 to S811 are the certificate issuance request setting process, in which information necessary for the multi function peripheral 100 to request the certificate authority and registration authority 102 to issue a certificate is input through an RUI (setting screen). S812 to S815 are the certificate issuance request process, in which the multi function peripheral 100 requests the certificate authority and registration authority 102 to issue a certificate and obtains the certificate.

First, the connection setting process will be described.

In S801, the multi function peripheral 100 receives a request to display the connection setting screen from the PC 103. For example, in order to configure the connection settings to the certificate authority and registration authority 102, the user of the multi function peripheral 100 selects connection settings 912 from a menu list 910 provided in the RUI to thereby transmit a request to display the connection setting screen to the multi function peripheral 100.

In S802, the multi function peripheral 100 generates HTML data of a connection setting screen 900 as illustrated in FIG. 9 with the web page control unit 304 as a response to S801 and displays it in the RUI.

In the present embodiment, using the web browser 604 installed on the PC 103, the user of the multi function peripheral 100 connects to an RUI that has been made public by the multi function peripheral 100, and performs operations such as inputting instructions into the RUI and inputting information into the RUI.

FIG. 9 is a diagram illustrating an example of the connection setting screen 900. The web page control unit 304 in FIG. 3 generates HTML data of the web page screen illustrated in FIG. 9, and the web browser 604 of the PC 103 displays it on the display 511. In the following description, screens are displayed through a similar procedure in the present embodiment, unless otherwise noted.

The connection setting screen 900 in FIG. 9 accepts input of information for the multi function peripheral 100 to connect to the certificate authority and registration authority 102. A host name of a server on which the certificate issuance service provided by the certificate authority and registration authority 102 operates is input into each of input fields 901, 903, and 905 provided in an area 920 in the connection setting screen 900. A connection destination port number is input into each of input fields 902, 904, and 906. An OK button 907 is operated in a case of completing the input. The multi function peripheral 100 connects to the certificate authority and registration authority 102 based on the information set and saved on the connection setting screen 900.

In S803, the PC 103 displays the connection setting screen 900. The PC 103 accepts input of information by the user.

In S804, in response to an operation on the OK button 907 in the connection setting screen 900, the PC 103 transmits a request indicating configuration of the settings to the multi function peripheral 100.

in S805, the multi function peripheral 100 performs a connection setting configuration process. The key pair-certificate obtainment control unit 305 of the multi function peripheral 100 obtains the setting values of the host names (certificate issuance server names) and the port numbers included in the connection settings and saves them in the RAM 203 or the HDD 204. Also, the key pair-certificate obtainment control unit 305 of the multi function peripheral 100 assumes that the protocols corresponding to certificate issuance servers for which the user has configured connection settings are usable, and assumes that the protocols corresponding to certificate issuance servers for which the user has not configured connection settings are not usable. For each protocol, the key pair-certificate obtainment control unit 305 saves whether it is usable or not that is based on these connection settings in the second table 402 in FIG. 4B. Incidentally, in the second table 402 in FIG. 4B, information on each communication protocol used by the multi function peripheral 100 (use) indicating whether it is usable or not usable based on the specifications is initially set for each certificate issuance request protocol (request method) installed on the multi function peripheral 100.

In S806, the multi function peripheral 100 generates a screen indicating the set connection settings and displays it on the PC 103 as a response.

Next, the certificate issuance request setting process will be described.

In S807, the multi function peripheral 100 receives a request to display a certificate issuance request setting screen (hereinafter “setting screen”) transmitted from the browser of the PC 103. To request issuance of a desired certificate, the user of the multi function peripheral 100 selects a desired certificate issuance request protocol (request method) from the menu list 910 in the RUI displayed on the PC 103. Suppose that the multiple certificate issuance request protocols (request methods) supported by the multi function peripheral 100 are displayed in a selectable manner in the menu list 910.

In the present embodiment, an SCEP certificate issuance request 913, an EST certificate issuance request 914, and an ACME certificate issuance request 915 are displayed in the menu list 910 as the multiple protocols supported by the multi function peripheral 100. In a case where the user selects any one of the protocols, the PC 103 transmits a request to display a certificate issuance request setting screen corresponding to the protocol selected by the user to the multi function peripheral 100.

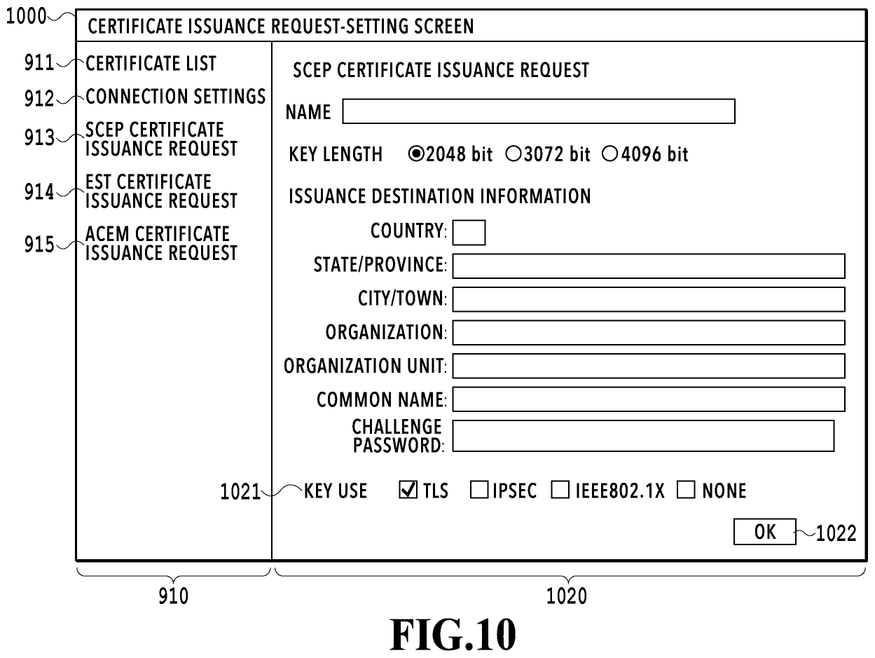

In S808, the multi function peripheral 100 generates HTML data of one of setting screens 1000, 1100, and 1200 in FIGS. 10 to 12 as a response to S807 and displays it in the RUI.

In S809, the PC 103 displays the certificate issuance request setting screen corresponding to the protocol selected by the user. Also, the PC 103 accepts input of information into the certificate issuance request setting screen 1000, 1100, or 1200 by the user. The certificate issuance request setting screens 1000, 1100, and 1200 will be described later.

In S810, in response to an operation on the OK button in the certificate issuance request setting screen, the PC 103 transmits a certificate issuance request to the multi function peripheral 100.

In S811, in response to receiving the certificate issuance request from the PC 103, the multi function peripheral 100 executes the certificate issuance request process based on the information input in the certificate issuance request setting screen 1000, 1100, or 1200. The certificate issuance request setting process is a process of generating certificate issuance request data based on the information input into the certificate issuance request setting screen 1000, 1100, or 1200 in S809. In this setting process, the multi function peripheral 100 determines the priority of the combination of the protocol selected from among the multiple protocols and a certificate use (key use) set in the setting screen 1000, 1100, or 1200. Moreover, in a case where a protocol with a higher priority is present for the currently set use, the multi function peripheral 100 notifies the user of that fact. Details of the certificate issuance request setting process will be described later.

In S812, based on the information set in S805, the multi function peripheral 100 transmits the certificate issuance request data generated in S811 to the certificate authority and registration authority 102, which is a corresponding server.

In S813, the multi function peripheral 100 receives a response to the certificate issuance request that is transmitted from the certificate authority and registration authority 102.

In S814, the multi function peripheral 100 performs an analysis process on the response to the certificate issuance request received in S813 (processes such as executing signature verification corresponding to the settings, obtaining the certificate contained in the response, and setting the obtained certificate to the designated use). The multi function peripheral 100 then generates a screen indicating the result of the certificate issuance request. In a case where the certificate has been successfully issued and obtained, the certificate data is saved in the multi function peripheral 100 by the process of S814.

In S815, the multi function peripheral 100 generates a screen indicating whether the certificate has been successfully issued and obtained or not, and transmits it to the PC 103.

FIGS. 10 to 12 are an example of the certificate issuance request setting screens 1000, 1100, and 1200 displayed by the web browser 604 of the PC 103. The multi function peripheral 100 requests the certificate authority and registration authority 102 to issue a certificate based on the setting values input into any of these setting screens 1000, 1100, and 1200. Also, the multi function peripheral 100 receives a certificate issued by the certificate authority and registration authority 102 and registers it in the multi function peripheral 100.

FIG. 10 illustrates an example of the setting screen 1000 for requesting issuance of a certificate by the SCEP method. This setting screen 1000 is displayed in a case where the SCEP certificate issuance request 913 is selected from the menu list 910. An input field 1020 in the setting screen 1000 includes multiple items to input information necessary for requesting issuance of a certificate by SCEP. Specifically, the input field 1020 includes “NAME,” “KEY LENGTH, issuance destination information (such as “COUNTRY,” “STATE/PROVINCE,” “CITY/TOWN,” “ORGANIZATION,” “ORGANIZATION UNIT,” and “COMMON NAME”), “CHALLENGE PASSWORD,” “KEY USE,” and the like. An OK button 1022 is a button to be operated in a case of completing the input into the input field 1020 and starting requesting issuance of a certificate.

The item “KEY LENGTH” is an item for setting the key length of a key pair to be generated. The item “CHALLENGE PASSWORD” is a password to be transmitted along with the certificate issuance request to the certificate authority and registration authority 102. The item “KEY USE” is an item setting the use of the certificate to be issued.

The use in “KEY USE” is meaning of the communication function for which the certificate will be used. In the present embodiment, communication protocols for encrypted communication such as TLS, IPsec, and IEEE 802.1X are selectable. Also, the multi function peripheral 100 in the present embodiment is capable of having certificates by multiple certificate issuance request protocols, and a use setting is configured for each of the multiple certificates (i.e., certificate issuance request protocols). For example, a certificate to be used by the multi function peripheral 100 in a case of providing a server service in which the multi function peripheral 100 performs TLS communication as a web server, and a certificate for the multi function peripheral 100 to perform client communication using IEEE 802.1X may involve different protocols. In such a case, the multi function peripheral 100 accepts a use setting for each individual certificate (protocol).

Also, “NONE” can be selected as “KEY USE.” The item “NONE” assumes that the use setting will be configured later. In a case where “NONE” is selected, the user will need to configure the use setting before the certificate is actually used.

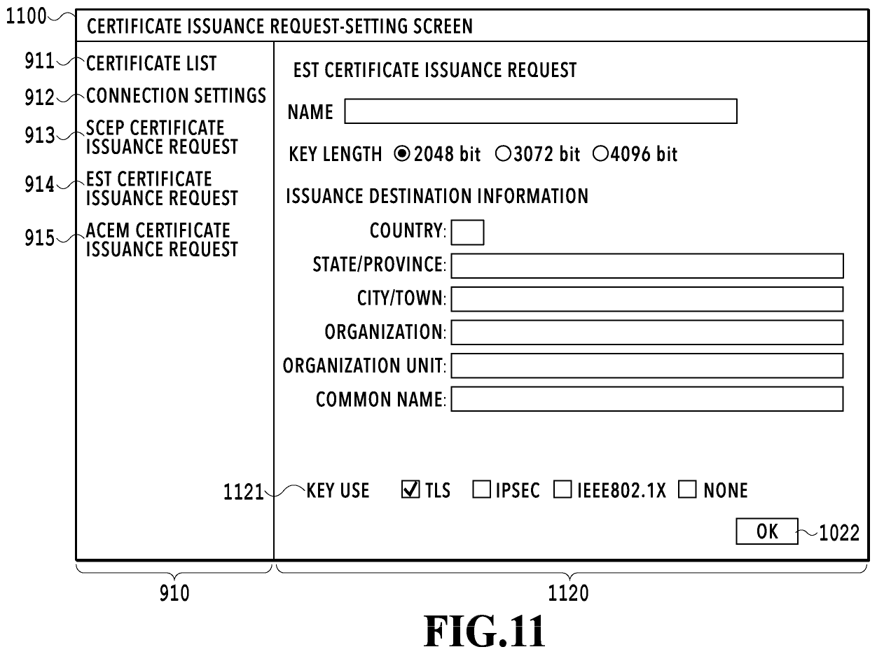

FIG. 11 illustrates an example of the setting screen 1100 for requesting issuance of an EST certificate. The setting screen 1100 is displayed in a case where the EST certificate issuance request 914 is selected from the menu list 910. The EST method setting screen 1100 and the SCEP method setting screen 1000 differ in that the EST method setting screen does not require setting “CHALLENGE PASSWORD.” The other setting items are the same as those in the SCEP method setting screen.

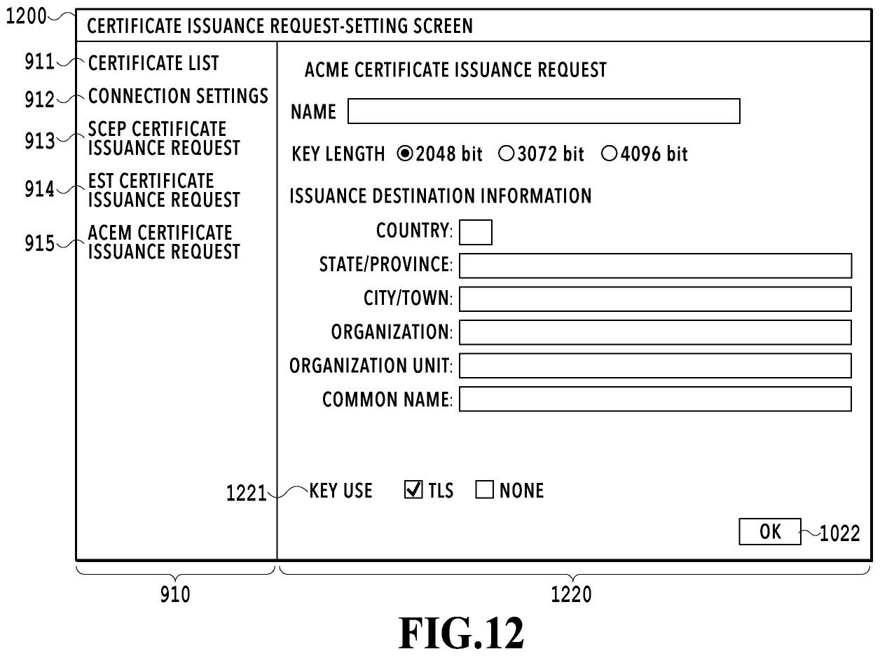

FIG. 12 illustrates an example of the setting screen 1200 for requesting issuance of an ACME certificate. The setting screen 1200 is displayed in a case where the ACME certificate issuance request 915 is selected from the menu list 910. The ACME method setting screen 1200 and the SCEP method setting screen 1200 differ in that the ACME method setting screen does not require setting “CHALLENGE PASSWORD.” Also, the ACME method setting screen only includes “TLS” and “NONE” as the options for “KEY USE” 1221, and IPsec and IEEE 802.1X are not selectable. The other setting items are the same as those in the SCEP method setting screen.

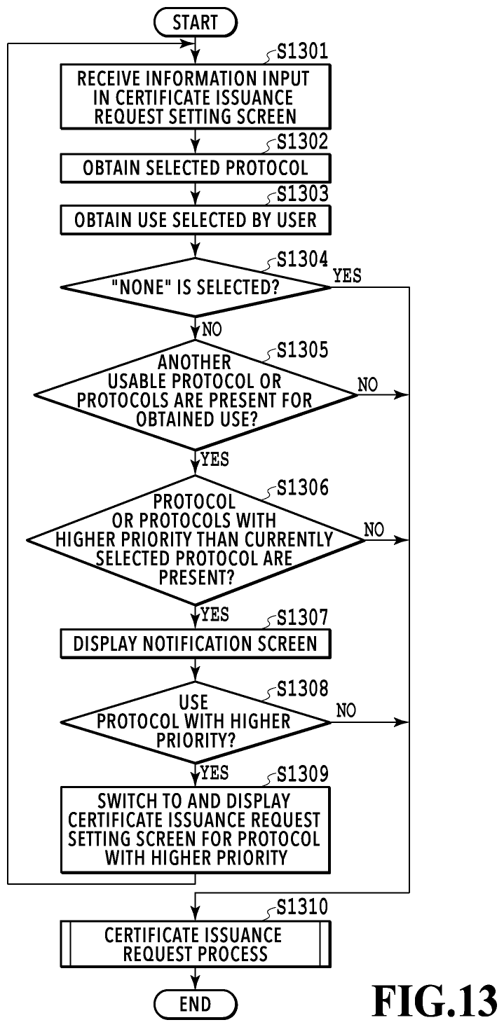

Next, the certificate issuance request setting process executed by the CPU 201 of the multi function peripheral 100 in S811 described above will be described with reference to FIG. 13. The processing illustrated in the flowchart is described in a program stored in the ROM 202 or the HDD 204. The program is called, loaded to the RAM 203, and executed by the CPU 201 of the multi function peripheral 100. The CPU 201 of the multi function peripheral 100 starts this processing in response to receiving a certificate issuance request by a protocol selected by the user from the PC 103 (S810). Each symbol “S” in the following description represents a step.

In S1301, the CPU 201 of the multi function peripheral 100 receives the information input in the setting screen for the protocol selected by the user from the PC 103 through an RUI. The CPU 201 obtains the information input in the input fields in the setting screen.

In S1302, the CPU 201 determines the protocol corresponding to the screen from which the certificate issuance request was received among SCEP, EST, and ACME, and then proceeds to S1303. In the present embodiment, the following description will be given by taking a case where the user has selected SCEP as an example.

In S1303, the CPU 201 obtains the value of “KEY USE” designated by the user, and then proceeds to S1304.

In S1304, the CPU 201 switches the following processing based on the value of “KEY USE” obtained in S1303. The CPU 201 proceeds to S1310 if “NONE” has been selected as “KEY USE.” The CPU 201 proceeds to S1305 if an option other than “NONE” has been selected as “KEY USE.”

In S1305, the CPU 201 confirms whether another usable protocol or protocols are present for the value of “KEY USE” obtained in S1303. The CPU 201 proceeds to S1306 if another usable protocol or protocols are present, and proceeds to S1310 if no other usable protocol is present.

In the determination in S1305, the CPU 201 refers to the second table 402 illustrated in FIG. 4B. The CPU 201 confirms whether a row (protocol) or rows (protocols) are present in the second table 402 in which “USABLE” is set in the column with the value of “KEY USE” obtained in S1303 besides the protocol obtained in S1302. If such a row or rows are present, the CPU 201 determines that another usable protocol or protocols are present. If no such a row is present, the CPU 201 determines that no other usable protocol is present.

The present embodiment will be described taking a case where TLS has been designated as “KEY USE” as an example. In the second table 402, ACME and EST are set as “USABLE” besides SCEP in the TLS column. The CPU 201 therefore determines that other usable protocols are present.

In S1306, the CPU 201 determines whether a request method or methods with higher priorities than the selected protocol obtained in S1302 are present among the usable protocols found in the determination in S1305. The CPU 201 proceeds to S1307 if such a request method or methods are present, and proceeds to S1310 if no such request method is present.

In the determination in S1306, the CPU 201 refers to the first table 401 illustrated in FIG. 4A. The CPU 201 confirms whether the first table 401 contains, in the column for the value of “KEY USE” obtained in S1303, a value or values smaller than the value in the row for the currently selected protocol among the values set in the rows for the usable protocols found in S1305. If such a value or values are present, the CPU 201 determines that a protocol or protocols with higher priorities than the currently selected protocol are present, and proceeds to S1307. If no protocol with a smaller value than the currently selected protocol is present, the CPU 201 determines that no method with a higher priority than the currently selected protocol is present, and proceeds to S1310.

In the above example, the value of SCEP, or the currently selected protocol, in the column for the use “TLS” in the first table 401, which is “3”, is compared with the values of the usable protocols found in S1305 (ACME and EST), which are “1” and “2.” Since “1” and “2” are smaller than “3,” it is determined in S1306 that methods with higher priorities than the selected protocol are present.

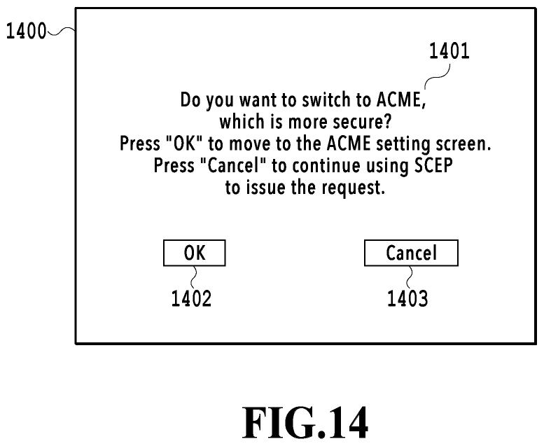

In S1307, the CPU 201 generates and displays a notification screen to be displayed in an RUI. The CPU 201 then proceeds to S1308. An example of the notification screen is illustrated in FIG. 14.

FIG. 14 is a diagram illustrating an example of a notification screen 1400. A message 1401, an OK button 1402, and a cancel button 1403 are displayed in the notification screen 1400. The message 1401 contains a notification related to security strength. The message 1401 also contains an inquiry to the user regarding whether they wish to switch to a protocol recommended to be used. The protocol recommended to be used is a protocol with a higher priority than the currently set protocol for the currently selected use. Preferably, the protocol recommended to be used is the protocol with the highest priority for the currently selected use. The OK button 1402 is operated in a case of following the message and switching to the recommended protocol. The cancel button 1403 is operated in a case of not following the message and continuing using the currently selected protocol.

The notification screen 1400 illustrated in FIG. 14 includes the message 1401 “Do you want to switch to ACME, which is more secure?” This message 1401 provides a notification regarding security strength, and a recommendation to switch to a protocol with a higher priority. Note that the content of the message is not limited to this example, and may be any content.

The CPU 201 proceeds to S1309 if switching to the protocol with a higher priority is selected on the notification screen 1400, i.e., the OK button 1402 is operated. The CPU 201 proceeds to S1310 if continuing to use the current protocol is selected, i.e., the cancel button 1403 is operated.

In S1309, the CPU 201 displays the certificate issuance request setting screen for the protocol with a higher priority in the notification screen 1400 recommended to be used in an RUI, and returns to S1301. In the example of FIG. 14, in which ACME is recommended to be used, the CPU 201 displays the setting screen 1200 illustrated in FIG. 12, which is for requesting issuance of a certificate by the ACME method, in the RUI.

The CPU 201 executes S1301 to S1309 with the setting screen 1200 for the switched certificate issuance request protocol. Note that, in the case where the use is TLS, ACME is a usable protocol and has the highest priority, and the CPU 201 therefore determines NO in S1304, YES in S1305, and NO in S1306, thereby proceeding to S1310.

In S1310, the CPU 201 executes the certificate issuance request process by the currently selected protocol for the certificate authority and registration authority 102, and terminates this flowchart. The processing in FIG. 13 enables the user to execute the certificate issuance request process by the certificate issuance request protocol with the highest priority for the certificate use.

Note that, in the above example, manual issuance has been presented as an example in which the user completes configuring the settings in the certificate issuance request setting screen illustrated in FIG. 10, 11, or 12 and then the certificate issuance request process is executed. However, the present disclosure is also applicable to automatic issuance in which the certificate issuance request process is executed on a designated date and time.

In the case of the automatic issuance, the CPU 201 of the multi function peripheral 100, for example, executes the processes of S1301 to S1309 in a similar manner to the above-described example, and then accepts designation of a date and time at which to request issuance. In a case where a date and time is designated, the CPU 201 saves the designated date and time and the values set in the certificate issuance request setting screen in the certificate obtainment information 321. When the designated date and time comes, the CPU 201 executes the certificate issuance request process of S1310.

In the case of the automatic issuance, the CPU 201 may execute the determination process illustrated as S1304 to S1306 before transmitting a certificate issuance request to the certificate authority and registration authority 102 at the designated date and time. In that case, if a protocol or protocols with higher priorities than the selected protocol are present for the selected use, the CPU 201 notifies of a protocol recommended to be used. Here, in a case where the notification is made in an RUI as illustrated in FIG. 14, the user may not be able to confirm the notification. For this reason, the CPU 201 may use another communication method such as e-mail or a push notification to a registered terminal to give the notification to the user in S1308.

As described above, in an environment where multiple certificate issuance request protocols are usable, the multi function peripheral 100 determines whether a certificate use selected on a setting screen for a selected certificate issuance request protocol is appropriate, and makes a notification in a case where a combination with a higher priority is present. Hence, even in a case where the user unintentionally attempts to request issuance of a certificate by a combination with a low security level, the notification can prompt the user to switch to a request protocol with a higher priority. This makes it possible to prevent the user from erroneously configuring settings for requesting issuance of an electronic certificate in an environment in which multiple certificate issuance request protocols are usable, and thus improve user friendliness. Moreover, a security deterioration due to a mismatch between the use of the electronic certificate and the certificate issuance request protocol to be used will be prevented.

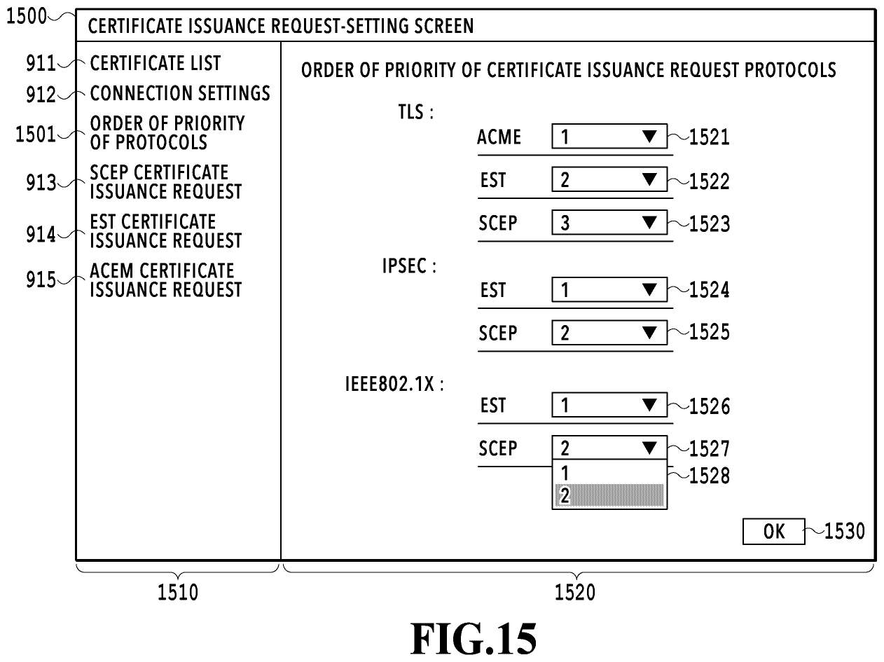

Note that the priorities are set and held as illustrated in FIG. 4A in the above example, but the user may set the priorities. In the following, the setting of the priorities in the multi function peripheral 100 will be described with reference to FIG. 15.

FIG. 15 is a diagram illustrating an example of a setting screen 1500 for setting the order of priority of the certificate issuance request protocols for each certificate use. The setting screen 1500 in FIG. 15 is displayed in a case where an “ORDER OF PRIORITY OF PROTOCOLS” menu 1501 is selected from a menu list 1510 in an RUI. Also, the order of priority set in the setting screen 1500 is held in the certificate obtainment information 321 in the format of the first table 401 illustrated in FIG. 4A, for example.

In an area 1520 in the setting screen 1500 for the order of priority, input fields 1521 to 1527 for the order of priority of the usable protocols are provided for each of the multiple certificate uses (TLS, IPsec, and IEEE 802.1X). A numeric value can be selected on each of the input fields 1521 to 1527 in the form of a pull-down list 1528. The numeric value represents a ranking, where a small value indicates a higher priority while a larger value indicates a lower priority.

Note that the setting screen 1500 is controlled such that the same value of priority cannot be set for different protocols for the same use. Assume, for example, that “1,” “2,” and “3” are set for ACME, EST, and SCEP, respectively, for the use “TLS.” In a case where the user changes the priority of ACME to “2” from the above state, the CPU 201 changes the priority of EST from “2” to “1” in correspondence to that change. As a result, ACME is set to “2,” EST is set to “1,” and SCEP is set to “3.”

In this way, the user can set the order of priority of combinations of a use and a certificate issuance request protocol. The user can flexibly configure the settings according to the required security strength, the usability of each protocol, and the like.

### Second Embodiment

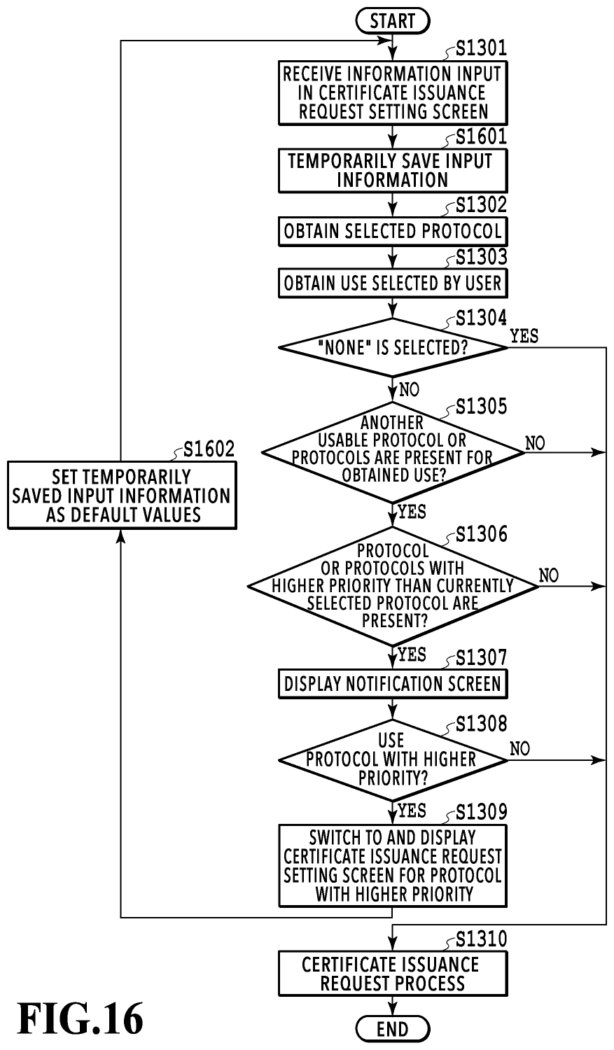

Next, a second embodiment of the present disclosure will be described with reference to FIG. 16. As described in the first embodiment, a notification is made regarding a combination of a certificate issuance request protocol and a certificate use (communication protocol), followed by switching to a setting screen for a certificate issuance request protocol with a higher priority in response to the user's instruction. In the second embodiment, the values set by the user in the setting screen before the switching are reflected and displayed in the screen after the switching.

The hardware configurations and functional arrangements of the multi function peripheral 100 and the PC 103 in the second embodiment are similar to those in the first embodiment (FIGS. 1 to 6). Thus, the same elements are denoted by the same reference signs, and detailed description thereof is omitted. Also, the entire procedure for the configuration of the connection settings for requesting issuance of a certificate and the requesting of issuance of the certificate (FIG. 8), and the RUIs (FIGS. 9 to 12 and 14) are similar to those in the first embodiment.

FIG. 16 is a flowchart explaining a flow of the certificate issuance request setting process in the second embodiment. This flowchart is the flowchart illustrated in FIG. 13 with the processes of S1601 and S1602 added thereto. The same steps are denoted by the same step numbers as those in FIG. 13. S1601 is added between S1301 and S1302. S1602 is a process executed in a case where the setting screen is switched one for a protocol with a higher priority in S1309. The difference from the first embodiment will be mainly described below.

As in the first embodiment, the CPU 201 of the multi function peripheral 100 starts the processing of this flowchart in response to receiving a certificate issuance request by a selected method from the PC 103 (S810).

In S1301, the CPU 201 of the multi function peripheral 100 receives the information input in the certificate issuance request setting screen for the protocol selected by the user from the PC 103 through an RUI. The CPU 201 obtains the values input in the input fields in the setting screen.

Here, in S1601, the CPU 201 temporarily saves the information input in the input fields in the certificate issuance request setting screen into the RAM 203. The CPU 201 then proceeds to S1302.

The processes of S1302 to S1309 are similar to those in the first embodiment. Specifically, the CPU 201 obtains the value of “KEY USE” set in the setting screen for the protocol selected by the user (SCEP, EST, or ACME). The CPU 201 determines whether another usable protocol or protocols are present for the obtained value of “KEY USE” by referring to the second table 402. If another usable protocol or protocols are present, the CPU 201 determines whether a protocol or protocols with higher priorities than the currently selected protocol are present among the usable protocols by referring to the first table 401. If a protocol or protocols with higher priorities than the selected protocol are present, the CPU 201 displays a notification screen as illustrated in FIG. 14 through an RUI. In a case where the user chooses to use a protocol with a higher priority in the notification screen, the CPU 201 switches to the certificate issuance request setting screen for the protocol with the highest priority for the selected use.

Then, in S1602, the CPU 201 reflects the input information saved in the RAM 203 in S1601 in the input fields in the switched certificate issuance request setting screen as default values. For example, in a case where the user switches to ACME from SCEP after the notification in S1307, the ACME certificate issuance request setting screen 1200 is displayed in an RUI. At this time, the pieces of information input by the user into the SCEP certificate issuance request setting screen 1000 are input and displayed in the corresponding items in the ACME certificate issuance request setting screen 1200 (“NAME” and “ISSUANCE DESTINATION INFORMATION”).

After displaying the setting screen for the protocol with a higher priority, the CPU 201 returns to S1301. The CPU 201 executes S1301, S1601, and S1302 to S1309 with the certificate issuance request setting screen displayed after the switching.

Then, proceeding to S1310, the CPU 201 executes the certificate issuance request process by the currently selected protocol for the certificate authority and registration authority 102, and terminates this flowchart.

As described above, in a case of switching the certificate issuance request setting screen to one for a protocol with a higher priority in the certificate issuance request setting process, the CPU 201 of the multi function peripheral 100 reflects the information input in the setting screen before the switching in the setting screen after the switching. In this way, the user can save the effort of inputting the same contents again, and efficiently configure the certificate issuance request settings.

### Third Embodiment

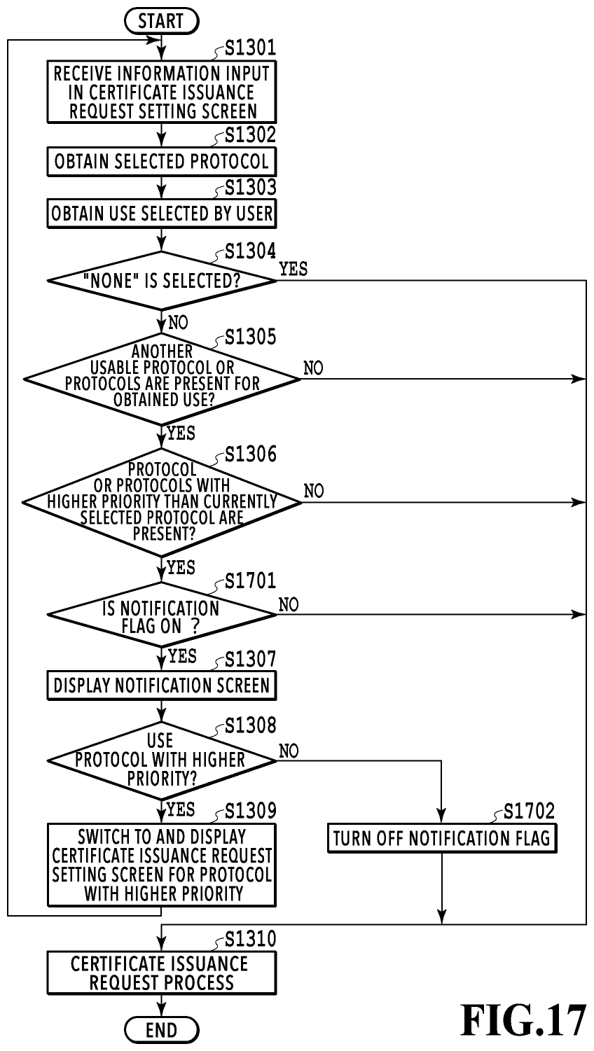

Next, a third embodiment of the present disclosure will be described with reference to FIG. 17. In the first embodiment, the notification screen is displayed in a case where the certificate issuance request setting screen meets the following conditions (1) to (3).
Condition (1): “NONE” is not set as “KEY USE” (S1304).
Condition (2): A usable protocol or protocols are present other than the currently selected protocol for the set use (S1305).
Condition (3): A protocol or protocols with higher priorities than the currently selected protocol are present for the set use (S1306).

In the third embodiment, enabling a notification setting is included as a condition for making the notification in addition to the above three conditions. The notification setting is a setting for controlling whether to notify that a protocol or protocols are present other than the currently selected protocol which are usable and have higher priorities, in a case where such a protocol or protocols are present. For example, a notification flag is provided, and that the notification flag is on is added to the above conditions for making the notification.

Note that the hardware configurations and functional arrangements of the multi function peripheral 100 and the PC 103 in the third embodiment are similar to those in the first embodiment (FIGS. 1 to 6). Thus, the same elements are denoted by the same reference signs, and detailed description thereof is omitted. The entire procedure for the configuration of the connection settings for requesting issuance of a certificate and the requesting of issuance of the certificate (FIG. 8), and the RUIs (FIGS. 9 to 12 and 14) are similar to those in the first embodiment.

FIG. 17 is a flowchart explaining a flow of the issuance request setting process in the third embodiment. This flowchart is the flowchart of FIG. 13 with the processes of S1701 and S1702 added thereto, and the same steps as those in FIG. 13 are denoted by the same step numbers. S1701 is a process executed in a case where it is determined YES in S1306. S1702 is a process executed in a case where the user does not choose to use a protocol with a higher priority in S1308. The difference from the first embodiment will be mainly described below.

As in the first embodiment, the CPU 201 of the multi function peripheral 100 starts the processing of this flowchart in response to receiving a certificate issuance request by a selected method from the PC 103 (S810).

The processes of S1301 to S1310 are similar to those in the first embodiment. Specifically, the CPU 201 of the multi function peripheral 100 receives the information input in the certificate issuance request setting screen for the protocol selected by the user from the PC 103 through an RUI. The CPU 201 obtains the values input in the input fields in the setting screen. The CPU 201 obtains the value of “KEY USE” set in the setting screen for the protocol selected by the user (SCEP, EST, or ACME).

In S1304 to S1306, the CPU 201 determines whether the above conditions (1) to (3) are met. In the third embodiment, if all of the conditions are met in S1304 to S1306, the CPU 201 makes a determination in S1701.

In S1701, the CPU 201 determines whether the notification flag is on or off. The notification flag is a flag in which information is set that indicates whether to make the notification in the case where a protocol or protocols with higher priorities than the currently selected protocol are present for the selected use. The notification flag is initially on. If the notification flag is on, the CPU 201 proceeds to S1307 and displays the notification screen, which indicates that a protocol or protocols with higher priorities than the currently selected protocol are present, in an RUI.

If the user does not choose to switch to a protocol with a higher priority on the notification screen in S1307, the CPU 201 turns off the notification flag. In this way, in a case where the user purposely requests issuance of a certificate by the method with the lower priority, the same notification will not be presented if a certificate issuance request is made by the same combination in the future. Note that, with a different combination, the user determination will not necessarily be the same, and therefore the notification flag is set based on the combination of the use and the protocol.

If the notification flag is off in S1701, the CPU 201 proceeds to S1310. Specifically, the CPU 201 skips the notification process and executes the certificate issuance request process of S1310 by the currently selected protocol.

If the user chooses to switch to a protocol with a higher priority in response to the notification in S1307, the CPU 201 proceeds to S1309. In S1309, the CPU 201 switches to the certificate issuance request setting screen for the protocol with the highest priority, and returns to S1301. If the user does not choose to switch to a protocol with a higher priority in response to the notification in S1307, the CPU 201 proceeds to S1702.

In S1702, the CPU 201 turns off the notification flag. The CPU 201 then proceeds to S1310. Then, the CPU 201 executes the certificate issuance request process by the selected protocol, and terminates this flowchart.

Note that, a notification setting menu, for example, may be provided in the menu list in an RUI so that the notification flag can be turned on again by the user's operation. On the notification setting menu, the ON/OFF of the notification setting (notification flag) is switchable by the user's operation for each combination of a use and a certificate issuance request protocol. Incidentally, the configuration of the notification setting is not limited to the method using the notification flag described above, and may be implemented by any other method.

As described above, in a case where the user purposely selects a protocol with a low priority in the certificate issuance request generation process, the CPU 201 of the multi function peripheral 100 saves that setting. This makes it possible to omit making the same notification in the future.

### Fourth Embodiment

Next, a fourth embodiment of the present disclosure will be described.

The multi function peripheral 100 in each foregoing embodiment makes a notification regarding a combination of a user-selected protocol and a user-selected use after the user inputs information into a certificate issuance request setting screen. In the fourth embodiment, in a case where multiple combinations of a protocol and a use are present, the multi function peripheral 100 makes a second combination with a lower priority than a first combination with the highest priority unselectable to the user. This enables the user to select a protocol and a use without confusion.

The hardware configurations and functional arrangements of the multi function peripheral 100 and the PC 103 in the fourth embodiment are similar to those in the first embodiment (FIGS. 1 to 6). Thus, the same elements are denoted by the same reference signs, and detailed description thereof is omitted. Also, the entire procedure for the configuration of the connection settings for requesting issuance of a certificate and the requesting of issuance of the certificate (FIG. 8) is similar to that in the first embodiment.

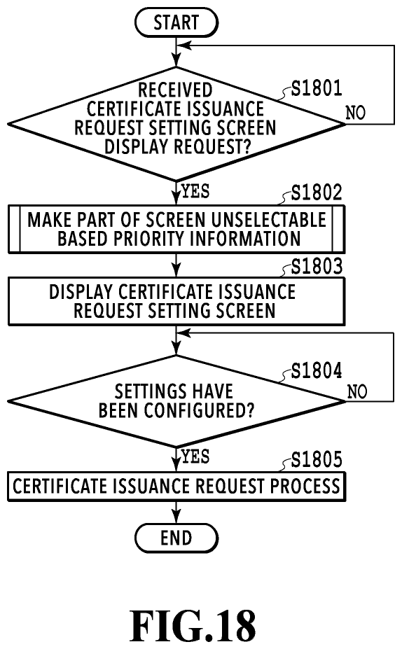

FIG. 18 is a flowchart explaining a flow of the certificate issuance request setting process in the fourth embodiment. The processing illustrated in this flowchart is executed by the multi function peripheral 100, for example, after a request to display a certificate issuance request setting screen is transmitted to the multi function peripheral 100 from the PC 103 in S807 in FIG. 8.

In S1801, the CPU 201 of the multi function peripheral 100 receives the certificate issuance request setting screen display request transmitted from the PC 103, and then proceeds to S1802.

In S1802, the CPU 201 obtains priority information stored in the HDD 204, and generates a certificate issuance request setting screen based on the priority information. The priority information is information indicating the priorities of combinations of a protocol and a use, such as the first table 401 illustrated in FIG. 4A. The CPU 201 refers to the first table 401 in FIG. 4A and, in a case where a second combination with a lower priority than a first combination with the highest priority is present, generates a setting screen in a display state where the user cannot select the second combination. The display state where the user cannot select the second combination is a state where UI elements related to the second combination are masked. UI elements are objects forming the screen, and are, for example, objects representing menus in a menu list 1910, input field objects in an input field 1920, and so on. Being “masked” refers to a display state which accepts no operation and in which the UI element is grayed out or not displayed. The CPU 201 then proceeds to S1803. Details of the process of S1802 will be described later. Specific examples of the screen will be described later.

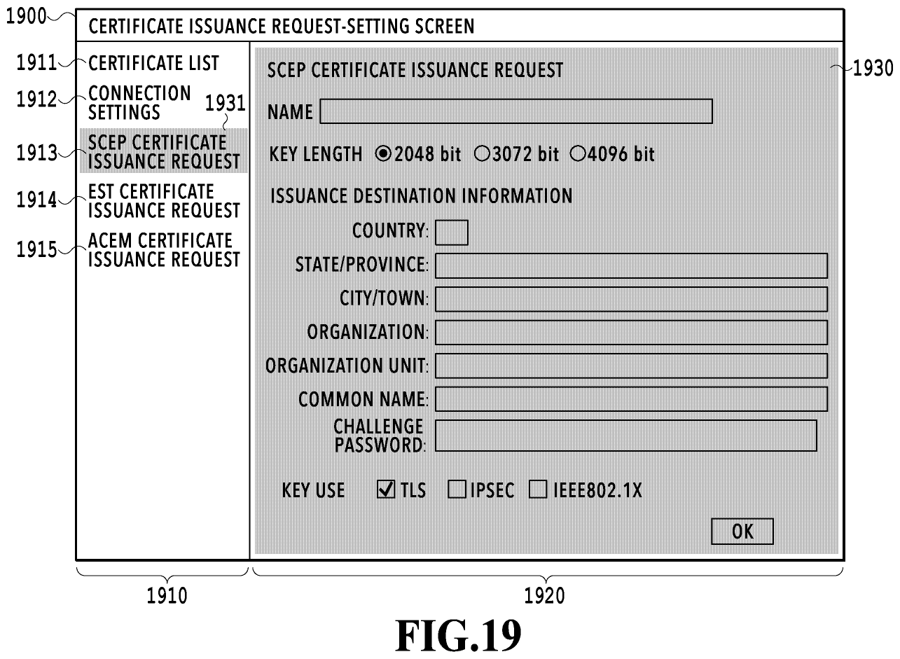

In S1803, the CPU 201 displays the certificate issuance request setting screen generated in S1802 in an RUI. The operator of the multi function peripheral 100 uses the web browser 604 installed on the PC 103 to connect to an RUI for requesting issuance of a certificate and obtaining the certificate that has been made public by the multi function peripheral 100, display the certificate issuance request setting screen, and perform operations thereon. Now, examples of the certificate issuance request setting screen will be described with reference to FIGS. 19 to 21.

FIGS. 19 to 21 are an example of certificate issuance request setting screens 1900, 2000, and 2100 in the fourth embodiment. These setting screens 1900, 2000, and 2100 are displayed on the web browser 604 installed on the PC 103. In S1802, some of the UI elements in the setting screen 1900, 2000, or 2100 are masked so that issuance of a certificate will not be requested by a combination with a low priority. Specifically, UI elements forming the screen are masked so as to keep the user from selecting the second combination with a lower priority than the first combination with the highest priority.

The CPU 201 of the multi function peripheral 100 accepts setting of information in the certificate issuance request setting screen 1900, 2000, or 2100 by the user, and requests the certificate authority and registration authority 102 to issue a certificate based on the values set by the user. Also, the CPU 201 registers the certificate thus issued in the multi function peripheral 100.

FIG. 19 is an example of the SCEP certificate issuance request setting screen 1900 with some of its UI elements masked. As indicated by reference signs 1930 and 1931, the entire input field 1920 and an SCEP certificate issuance request 1913 in the menu list 1910 are masked and therefore cannot be operated by the user. This is because the multi function peripheral 100 is equipped with protocols (EST and ACME) that have higher priorities than SCEP when combined with any of the uses (TLS, IEEE 802.1X, and IPsec).

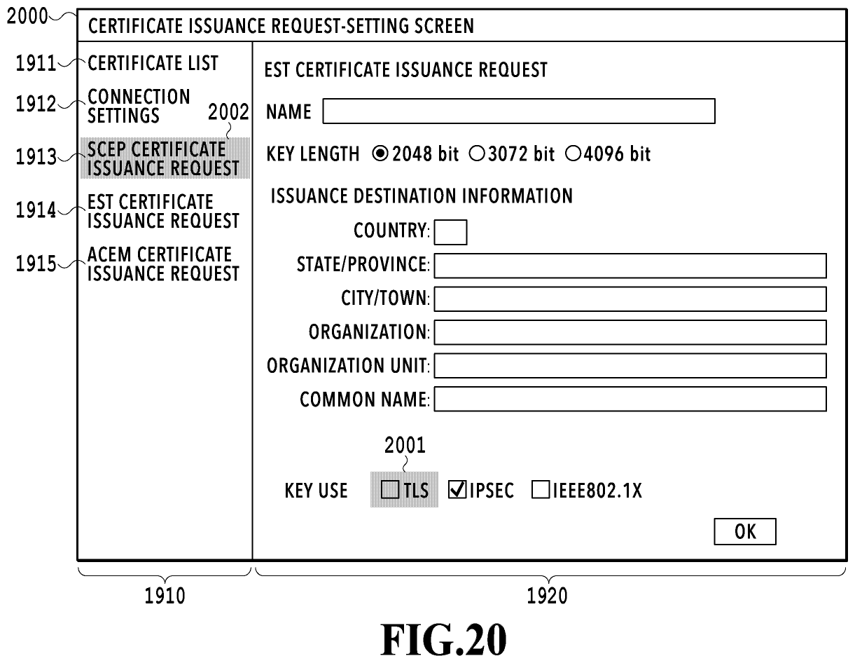

FIG. 20 is an example of the EST certificate issuance request setting screen 2000 with some of its UI elements masked. As indicated by reference sign 2002, the SCEP certificate issuance request 1913 in the menu list 1910 is masked. Moreover, as indicated by reference sign 2001, “TLS” in the “KEY USE” section in the input field 1920 is masked. Specifically, for the EST certificate issuance request, “TLS” is displayed such that it is unselectable as “KEY USE.”

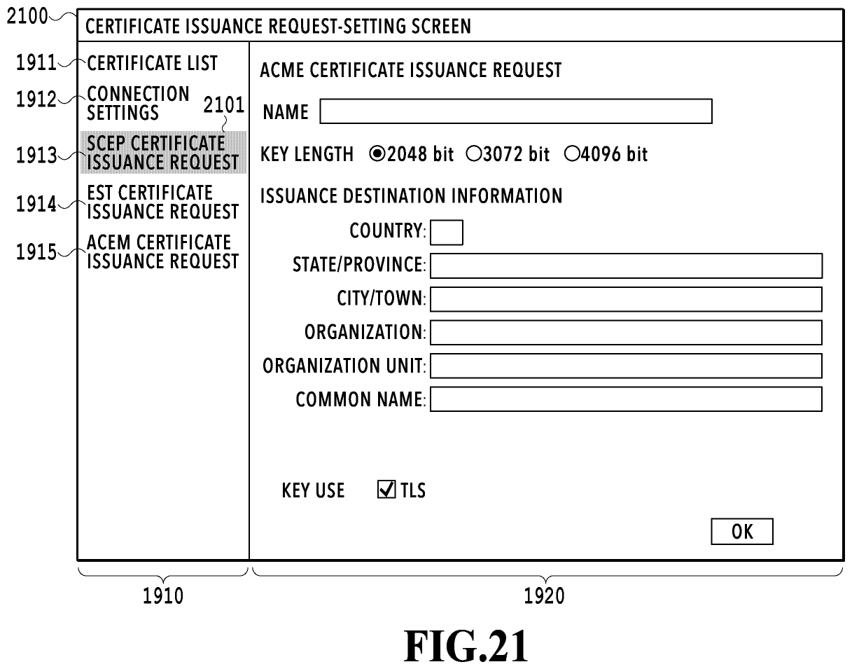

FIG. 21 is an example of the ACME certificate issuance request setting screen 2100. As indicated by reference sign 2101, the display is controlled such that the SCEP certificate issuance request 1913 in the menu list 1910 is masked to thereby keep the user from operating it. Moreover, the display is controlled such that the uses in the “KEY USE” section in the input field 1920 are not displayed and will therefore not be operated by the user except “TLS.”

The description now returns to FIG. 18.

In S1804, the CPU 201 waits until the user completes inputting setting values into an RUI (certificate issuance request setting screen), and proceeds to S1805 if the user completes inputting setting values.

In S1805, the CPU 201 executes the certificate issuance request process by the selected certificate issuance request protocol, and terminates this flowchart.

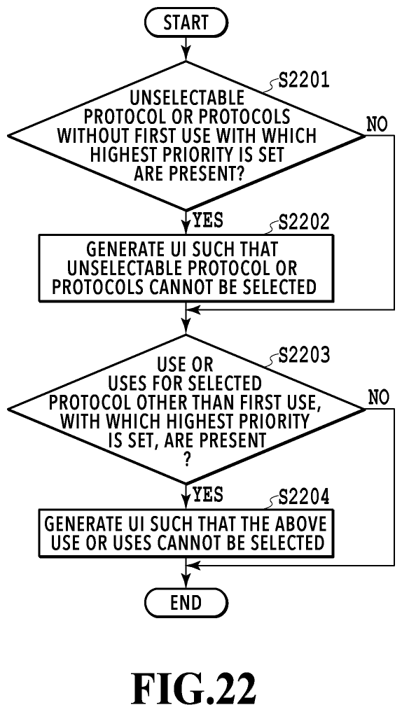

FIG. 22 is a flowchart illustrating a procedure of the UI masking process executed in S1802 in FIG. 18. In this flowchart, the CPU 201 generates a UI (certificate issuance request setting screen) based on the priority information related to the certificate issuance request protocol requested in the display request received from the PC 103 in S1801. Specifically, the CPU 201 refers to the first table 401 illustrated in FIG. 4A and generates a setting screen in which the protocol or protocols with lower priorities are masked so as not to be selected by the user. The following description will be given based on a case where an EST certificate issuance request 1914 has been selected from the menu list 1910, and a request to display the setting screen for the EST certificate issuance request 1914 has been received as an example.

In S2201, the CPU 201 determines whether the first table 401 illustrated in FIG. 4A contains a protocol or protocols without a use with which the highest priority is set (hereinafter “first use”) (hereinafter such a protocol will be referred to as “unselectable protocol”). The CPU 201 proceeds to S2202 if the first table 401 contains an unselectable protocol or protocols, and proceeds to S2203 if the first table 401 contains no unselectable protocol. In the example of the first table 401 illustrated in FIG. 4A, TLS is set as a first use (priority “1”) for the protocol “ACME.” IEEE 802.1X and IPsec are first uses (priority “1”) for the protocol “EST.” In the row for the protocol “SCEP,” on the other hand, there is no first use with which priority “1” is set. SCEP is therefore identified as the unselectable protocol mentioned above. In sum, it is considered that the multi function peripheral 100 should not use the protocol “SCEP” for any of the uses from the perspective of security and the like that determine the priority.

In S2202, the CPU 201 generates a UI such that a selecting operation cannot be performed on the unselectable protocol or protocols. Specifically, as illustrated in FIGS. 19, 20, and 21, the CPU 201 masks the SCEP certificate issuance request 1913 in the menu list 1910 so that no operation can be performed thereon. Also, as illustrated in FIG. 19, the CPU 201 masks the entire input field 1920 in the SCEP certificate issuance request setting screen 1900.

In S2203, the CPU 201 determines whether a use or uses are present for the protocol selected by the user (the protocol requested in the display request received in S2201) other than the first use, with which the highest priority is set, (hereinafter such a use will be referred to as “second use”). In other words, the CPU 201 determines whether a use or uses are present with which a priority lower than the first use is set (second use or uses). The CPU 201 proceeds to S2204 if a second use or uses are present, and terminates this flowchart if no second use is present. In the example of the first table 401, each use with which priority “2” or “3” is set is a second use. For example, taking the protocol “EST” as an example, the row for “EST” in the first table 401 has priority “2” set for the use “TLS” and priority “1” set for the uses “IEEE 802.1X” and “IPsec.” That is, in a case where the user has selected the protocol “EST,” “TLS” will be identified as a second use.

In S2204, the CPU 201 displays the UI so as to keep the user from selecting the second use or uses with low priorities, and terminates the processing. In the example described above, in the case where the user has requested issuance of an EST certificate, the CPU 201 generates the EST certificate issuance request setting screen 2000. At this time, the CPU 201 masks the UI element, such as a check box, for TLS (second use) in the “KEY USE” section, as illustrated in FIG. 20.

Note that, in a case where the user has requested issuance of an ACME certificate, the row for ACME in the first table 401 has priority “1” set for TLS and no priority set for IEEE 802.1X or IPsec. This means that the protocols other than TLS are not usable. In that case, as illustrated in FIG. 21, the check boxes in the “KEY USE” section other than that for TLS (first use) are masked (not displayed in FIG. 21).

As described above, in the fourth embodiment, the multi function peripheral 100 controls the display state of the setting screen based on the priority of the combination of the protocol and the use such that issuance of a certificate will not be requested by a combination with a low priority. This makes it possible to prevent the user from selecting a protocol and a use which together have a low priority. This makes it possible to prevent the user from erroneously configuring settings for requesting issuance of an electronic certificate in an environment in which multiple certificate issuance request protocols are usable, and thus improve user friendliness. Moreover, the user can request issuance of a certificate by a certificate issuance request protocol suitable for the use of the certificate. This prevents deteriorations in security level and functions due to a mismatch between the protocol and the use.

Note that order of the processes, the screen layouts, the input items in the setting screens, and so on described and illustrated in each of the above-described embodiments are mere examples, and the present disclosure is not limited to these. Also, the certificate issuance request protocols and the communication protocols (uses) are not limited to those exemplarily described, and may be part of these or include other protocols. Also, in a case of adding protocols to be installed on the multi function peripheral 100 and communication protocols or changing them, it is preferable to update the priority information and the availability information illustrated in FIGS. 4A and 4B.

Also, in the description of the above embodiments, the display of screens and the input thereinto are done through RUIs between the multi function peripheral 100 and the PC 103. Alternatively, the screens described in each of the embodiments may be displayed on the operation panel of the multi function peripheral 100, and the user may input information thereinto. Also, data may be transferred between the apparatuses in an offline state by using a universal serial use (USB) memory or the like.

Also, in the above embodiments, examples in which the CPU 201 of the multi function peripheral 100 executes the processes illustrated in FIGS. 13, 16, 17, 18, and 22 have been described, but the CPU 501 of the PC 103 may execute these processes. In that case, the PC 103 will be provided with functional units equivalent to the key pair-certificate obtainment control unit 305, the key pair-certificate management unit 307, the certificate obtainment information 321, the key-certificate information 322, the encryption processing unit 306, etc. illustrated in FIG. 3. Moreover, the PC 103 will be provided with the functions illustrated in the key pair-certificate obtainment control unit 305 in FIG. 7 as well.

Preferred embodiments according to the present disclosure have been described above with reference to the accompanying drawings. However, the present disclosure is not limited to those examples. It is apparent that those skilled in the art can arrive at various modifications and corrections within the purview of the technical idea disclosed in the present application, and it is to be understood that they naturally belong to the technical scope of the present disclosure.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to prevent the user from erroneously configuring settings for requesting issuance of an electronic certificate in an environment in which multiple certificate issuance request protocols are usable, and thus improve user friendliness.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-016392, filed Feb. 6, 2024, which is hereby incorporated by reference wherein in its entirety.

What is claimed is:

1. An information processing apparatus comprising:
a request unit configured to request a certificate issuance server to issue an electronic certificate by using one of a plurality of protocols;
an acceptance unit configured to accept selection of one of the plurality of protocols by a user and selection of one of a plurality of uses of the electronic certificate by the user; and
a notification unit configured to make a notification related to a combination of the protocol and the use the selection of which was accepted by the acceptance unit.

2. The information processing apparatus according to claim 1, further comprising an obtaining unit configured to obtain priority information being information in which a priority is set for a combination of each of the plurality of uses and each of the plurality of protocols, wherein
the notification unit makes the notification in a case of determining based on the priority information obtained by the obtaining unit that a second combination with a higher priority than a first combination is present, the first combination being the combination of the use and the protocol the selection of which was accepted by the acceptance unit.

3. The information processing apparatus according to claim 2, wherein the notification to be made by the notification unit includes presenting a protocol recommended to be used for the use the selection of which was accepted by the acceptance unit.

4. The information processing apparatus according to claim 3, wherein the protocol recommended to be used is the protocol in the second combination.

5. The information processing apparatus according to claim 1, wherein the acceptance unit displays a first UI screen for the user to set information necessary for requesting issuance of the electronic certificate by using the protocol the selection of which was accepted by the acceptance unit, and to set a use of the electronic certificate.

6. The information processing apparatus according to claim 3, wherein the acceptance unit further accepts switching to the protocol recommended to be used.

7. The information processing apparatus according to claim 6, wherein in a case of accepting switching to the protocol recommended to be used, the acceptance unit displays a second UI screen for the user to set information necessary for requesting issuance of the electronic certificate by using the protocol recommended to be used, and to set a use of the electronic certificate.

8. The information processing apparatus according to claim 7, wherein the acceptance unit reflects information set in a first UI screen in the second UI screen, the information being information necessary for requesting issuance of the electronic certificate by using the protocol the selection of which was accepted by the acceptance unit, the first UI screen being a screen for the user to set the information necessary for requesting issuance of the electronic certificate and to set a use of the electronic certificate.

9. The information processing apparatus according to claim 1, further comprising a setting unit configured to set whether to make the notification by the notification unit, wherein
the notification unit makes the notification in a case where the setting unit has enabled a setting to make the notification.

10. The information processing apparatus according to claim 9, wherein
the notification to be made by the notification unit includes presenting a protocol recommended to be used for the use the selection of which was accepted by the acceptance unit, and
the acceptance unit further accepts switching to the protocol recommended to be used, and
in a case of not switching to the protocol recommended to be used, the setting unit enables a setting to not make the notification by the notification unit for a combination of the use the selection of which was accepted by the acceptance unit and the protocol recommended to be used.

11. The information processing apparatus according to claim 7, wherein in a case where the notification unit makes the notification, the request unit requests the certificate issuance server to issue the electronic certificate if the information necessary for requesting issuance of the electronic certificate by using the protocol recommended to be used and a use of the electronic certificate are set in the second UI screen.

12. The information processing apparatus according to claim 7, wherein the request unit requests the certificate issuance server at a designated date and time to issue the electronic certificate.

13. The information processing apparatus according to claim 1, wherein the notification unit displays the notification on a screen.

14. The information processing apparatus according to claim 1, wherein the notification unit transmits the notification by e-mail.

15. The information processing apparatus according to claim 2, wherein the priority information is set and held in advance.

16. The information processing apparatus according to claim 2, wherein the priority information is set by a user.

17. The information processing apparatus according to claim 1, wherein the notification to be made by the notification unit is related at least to security.

18. An information processing apparatus comprising:
a request unit configured to request a certificate issuance server to issue an electronic certificate by using one of a plurality of protocols;
an obtaining unit configured to obtain priority information being information in which a priority is set for a combination of each of a plurality of uses of the electronic certificate and each of the plurality of protocols; and
a display control unit configured to display a UI screen for a user to set information necessary for requesting issuance of the electronic certificate including a use of the electronic certificate in a display state reflecting the priority information obtained by the obtaining unit.

19. The information processing apparatus according to claim 18, wherein the display control unit displays the UI screen in a display state in which a second combination with a lower priority than a first combination with a highest priority is unable to be selected, based on the priority information obtained by the obtaining unit.

20. The information processing apparatus according to claim 18, wherein in a case where an unselectable protocol is present, the display control unit displays the UI screen in a display state in which the unselectable protocol is unable to be selected, based on the priority information obtained by the obtaining unit, the unselectable protocol being a protocol without a use with which a highest priority is set.

21. The information processing apparatus according to claim 19, wherein the display state in which the unselectable protocol is unable to be selected is to mask the use in the second combination.

22. The information processing apparatus according to claim 20, wherein the display state in which the unselectable protocol is unable to be selected is to mask a portion related to the unselectable protocol.

23. The information processing apparatus according to claim 1, wherein the plurality of protocols include ACME, EST, and SCEP.

24. The information processing apparatus according to claim 1, wherein the plurality of uses include TSL, IEEE 802.1X, and IPsec.

25. A method of setting a certificate issuance request, comprising:
requesting a certificate issuance server to issue an electronic certificate by using one of a plurality of protocols;
accepting selection of one of the plurality of protocols by a user and selection of one of a plurality of uses of the electronic certificate by the user; and
making a notification related to a combination of the protocol and the use the selection of which was accepted in the accepting.

26. A method of setting a certificate issuance request, comprising:
requesting a certificate issuance server to issue an electronic certificate by using one of a plurality of protocols;
obtaining priority information being information in which a priority is set for a combination of each of a plurality of uses of the electronic certificate and each of the plurality of protocols; and
displaying a setting screen for a user to set information necessary for requesting issuance of the electronic certificate including a use of the electronic certificate in a display state reflecting the priority information obtained in the obtaining.

27. A non-transitory computer readable storage medium storing a program which causes a computer to execute
requesting a certificate issuance server to issue an electronic certificate by using one of a plurality of protocols;
accepting selection of one of the plurality of protocols by a user and selection of one of a plurality of uses of the electronic certificate by the user; and
making a notification related to a combination of the protocol and the use the selection of which was accepted in the accepting.

28. A non-transitory computer readable storage medium storing a program which causes a computer to execute
requesting a certificate issuance server to issue an electronic certificate by using one of a plurality of protocols;
obtaining priority information being information in which a priority is set for a combination of each of a plurality of uses of the electronic certificate and each of the plurality of protocols; and
displaying a setting screen for a user to set information necessary for requesting issuance of the electronic certificate including a use of the electronic certificate in a display state reflecting the priority information obtained in the obtaining.
